(19) United States
(12) Patent Application Publication
(10) Pub. No.: US 2017/0374663 A1
(43) Pub. Date: Dec. 28, 2017

(54) ACCESS POINT RADIO FREQUENCY ADJUSTMENT

(71) Applicant: Aruba Networks, Inc., Houston, TX (US)

(72) Inventors: Jiwoong Lee, Sunnyvale, CA (US); Sachin Ganu, Sunnyvale, CA (US)

(21) Appl. No.: 15/190,473

(22) Filed: Jun. 23, 2016

(51) Int. Cl. H04W 72/04; H04W 76/02; H04W 28/02; H04L 12/761; H04W 84/12; H04W 88/08; H04W 88/16

(52) U.S. Cl. CPC H04W 72/0453; H04W 28/021; H04W 76/023; H04L 45/16; H04W 88/08; H04W 88/16; H04W 84/12

(57) ABSTRACT

In some examples, a method for Access Point (AP) radio frequency adjustment can include receiving, for a given AP in a wireless network, data regarding: (a) radios of a first set of neighboring APs that are available to serve, at a first frequency, a wireless client associated with the given AP, and (b) radios of a second set of neighboring APs that are available to serve, at a second frequency, the wireless client. The method can further include determining, for a radio of the given AP and based on the received data, a frequency redundancy for a set of wireless clients in the wireless network automatically adjusting a frequency of the radio of the given AP based on the determined frequency redundancy.

### BACKGROUND

Wireless networking can allow wireless devices, such as certain smartphones, laptops, tablets, or other suitable computing devices, to exchange data with other wired or wireless devices. In some wireless networks, a wireless client can access a wired portion of the network via one or more wireless access points. Wireless access points can be designed to communicate with wireless clients at one or more radio frequencies based on capabilities of network equipment or other factors.

### BRIEF DESCRIPTION OF DRAWINGS

FIG. 1 is a diagram of a network environment, according to an example.

FIG. 2 is a flowchart for a method, according to an example.

FIG. 3a is a diagram of frequency coverage for a network environment before radio frequency adjustment, according to an example.

FIG. 3b is a diagram of frequency coverage for a network environment after radio frequency adjustment, according to an example.

FIG. 4 is a diagram of a computing device, according to an example.

FIG. 5 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Wireless network equipment is often designed to remain stationary after installation and setup. In view of this, a network operator will generally estimate a peak traffic amount for a foreseeable future and then purchase, position, and configure equipment to meet the peak traffic amount. As a result, network resources are often underutilized. For example, access points (APs) often include at least two radios, with at least one radio dedicated for use in the 2.4 GHz frequency band and at least one radio dedicated for use in the 5 GHz frequency band. Such an AP may therefore service to two distinct wireless networks—i.e., a 2.4 GHz network and a 5 GHz network. The 5 GHz network may be considered preferable for use in some situations as it has wider bandwidth, can support faster modulation, and is often under less interference. On the other hand, 2.4 GHz electromagnetic waves tend to have better propagation with less attenuation and as a result, fewer 2.4 GHz radios can be used to cover a given area. For purposes of illustration, frequency bands of 2.4 GHz and 5 GHz are used throughout this disclosure. However, it is appreciated that other frequency bands may be suitable for use with the implementations of the present disclosure, such as for example 3.6 GHz, 4.9 GHz, 5.9 GHz bands, or any other suitable frequency band.

In some implementations of the present disclosure, a network capacity for a first frequency network can be increased by switching a set of redundant radios from a second frequency to the first frequency in a graceful and convenient way. One method described herein for AP radio frequency adjustment can, for example, include: (1) receiving, for a given AP in a wireless network, data regarding: (a) radios of a first set of neighboring APs that are available to serve, at a first frequency, a wireless client associated with the given AP, and (b) radios of a second set of neighboring APs that are available to serve, at a second frequency, the wireless client; (2) determining, for a radio of the given AP and based on the received data, a frequency redundancy for a set of wireless clients in the wireless network; and (3) automatically adjusting a frequency of the radio of the given AP based on the determined frequency redundancy. It is appreciated that certain implementations of the present disclosure can be used to enable network operators to deploy their radio network flexibly and dynamically by allowing the network to adapt to fluctuations in traffic over a large time scale. In some implementations, this may be achievable by software upgrade and without a change in hardware capabilities. Other advantages of implementations presented herein will be apparent upon review of the description and figures.

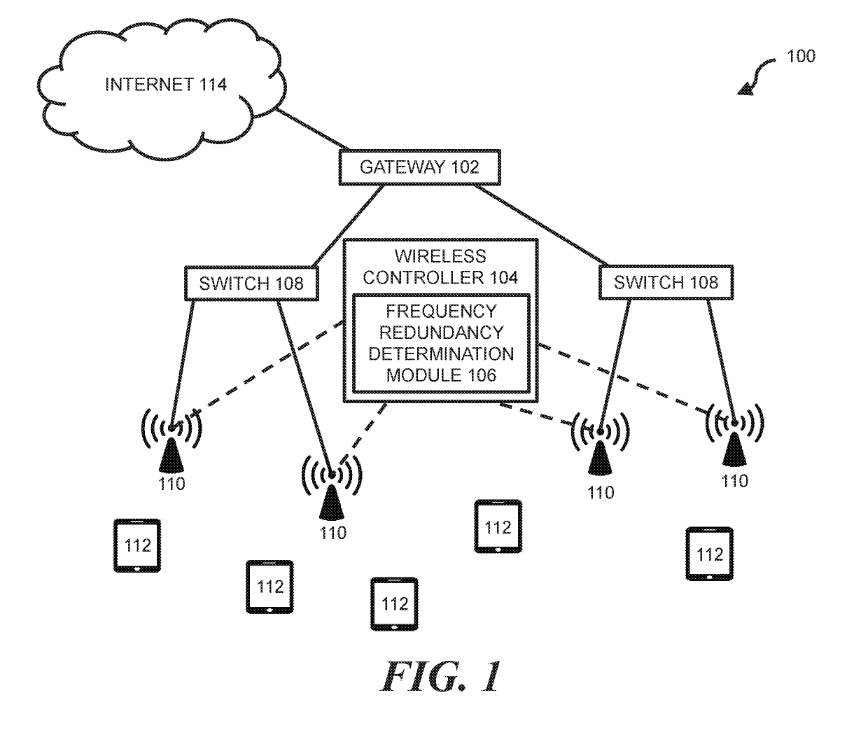

FIG. 1 is a diagram of an example network environment 100 that includes a local area network portion including a gateway 102, a wireless controller 104 having a frequency redundancy determination module 106, various switches 108, various APs 110, and various wireless clients 112. Network environment 100 of FIG. 1 depicts the local area network portion in data communication with the wider Internet 114 via gateway 102. The structure and functionality of the various aspects of environment 100 are described in further detail below.

The terms “access point” or “AP” as used herein, can, for example, refer to networking hardware device that allows a Wi-Fi compliant device to connect to a wired network. Such an AP may be connected upstream to a wired device via an Ethernet connection and may provide one or more downstream wireless connections using radio frequency links for other wireless devices to utilize that wired connection. Such an AP can support one or more industry standards for sending and receiving data using these radio frequencies, such as IEEE 802.11 or other suitable standards. Such an AP can be in the form of a standalone device connected to a gateway (e.g., gateway 102), router, or other intermediate datapath device. In some implementations, such an AP may be an integral component of such an intermediate datapath device or other network equipment.

As used herein, the term “wireless controller” can, for example, refer to any suitable entity that handles control and management functions of a network or equipment thereof. For example, wireless controller 104 can be used to control one or more aspects of APs 110, such as channel assignment, beamforming, radio resource management (RRM), etc. In some implementations, wireless controller 104 can allow for the decoupling of traffic routing control decisions (e.g., which port of a given switch should be used to forward traffic to a given destination) from the network's physical infrastructure. For example, in some implementations, wireless controller 104 can be in the form of an SDN controller and switches 108 can be in the form of SDN-enabled switches that are within the control domain of the SDN controller. One or more network nodes within environment 100 may be deemed to be “controlled” by another device, such as wireless controller 104. The term “controlled” is intended to include devices within the control domain of the wireless controller or otherwise controllable by the wireless controller. Such a controlled node can, for example, communicate with wireless controller 104 and can allow wireless controller 104 to manage the node in accordance with a protocol. For example, an OpenFlow-compatible switch controlled by a wireless controller with SDN capabilities may permit the controller to add, update, and delete flow entries in flow tables of the switch using suitable commands.

In some implementations, applications can run on wireless controller 104 or on other devices on the network (or otherwise in communication with the network) to meet customer use cases, such as to achieve a desired throughput (or another Quality of Service (QoS)) over the network, enforce security provisions or access control policies for the network, or provide another suitable service or functionality.

In some network environments, a data packet may be routed from a given switch 108 to a given wireless client 112 through one or more data paths that may include wireless links (e.g., a wireless link between AP 110 and wireless client 112). For example, in some network environments, a data packet may be routed to wireless client 112 along a first datapath that uses a first AP 110 or alternatively along a second datapath that uses a second AP 110. A given data path for data packets within environment 100 can be determined by wireless controller 104 (or another entity, such as by a network administrator, by datapath nodes themselves, etc.) based on one or more static parameters (e.g., link speeds, number of hops between nodes, etc.) and can further (or alternatively) be based on one or more dynamic parameters (e.g., QoS, network latency, network throughput, network power consumption, etc.).

Network nodes within environment 100 can forward traffic along a datapath based on metadata within the traffic. For example, traffic in the form of a packet can be received at switch 108 (or another suitable intermediary network node). For consistency, the industry term “packet” is used throughout this description, however, it is appreciated that the term “packet” as used herein can refer to any suitable protocol data unit (PDU). Such a packet can, for example, include payload data as well as metadata in the form of control data. Control data can, for example, provide data to assist the network node with reliably delivering payload data. For example, control data can include network addresses for source and destination nodes (e.g., wireless client 112), error detection codes, sequencing information, packet size of the packet, a time-to-live (TTL) value, etc. In contrast, payload data can include data carried on behalf of an application for use by source and destination nodes.

The functionality of wireless controller 104 can, for example, be implemented in part via a software program on a standalone machine, such as a standalone server. In some implementations, wireless controller 104 can be implemented on multi-purpose machines, such as a suitable desktop computer, laptop, tablet, or the like. In some implementations, wireless controller 104 can be implemented on a suitable non-host network node, such as certain types of network switches. In some implementations, the functionality of wireless controller 104 can be implemented within the hardware and software of an AP (e.g., AP 110). It is appreciated that the functionality of wireless controller 104 may be split among multiple controllers or other devices. For example, environment 100 is described and illustrated as including only one wireless controller 104. However, it is appreciated that the disclosure herein can be implemented in networks with multiple controllers. For example, in some networks, network devices are in communication with multiple controllers such that control of the network can be smoothly handed over from a first controller to a second controller if a first controller fails or is otherwise out of operation. In some implementations, or more wireless controllers 104 can operate in a distributed fashion over multiple appliances but present themselves as a single entity to the network.

As another example, multiple controllers can be used to work together to concurrently control certain networks. In such networks, a first controller can, for example, control certain network devices while a second controller can control other network devices. In view of the above, reference in this application to a single wireless controller 104 that controls the operation of network devices in environment 100 is intended to also include such multiple controller configurations (and other suitable multiple controller configurations).

Wireless clients 112 can, for example, be in the form of network hosts or other types of network nodes. Wireless clients 112 can, for example, be in the form of mobile devices that can transmit and receive wireless data with an AP 110. Wireless clients 112 can, for example, be in the form of suitable mobile phones, tablets, laptops, servers, desktop computers, printers, APs, wireless sensors, beacons, Internet of Things (IoT) devices, etc. In certain implementations, one or more wireless clients 112 can be in the form of a desktop computer including a monitor for presenting information to an operator and a keyboard and mouse for receiving input from an operator and one or more wireless clients 112 can be in the form of smart phones. It is appreciated that wireless clients 112 can be endpoint nodes of environment 100 (such as depicted in FIG. 1), intermediate nodes between endpoint nodes, or positioned at other logical or physical locations within environment 100.

Various intermediary nodes within the network environment can, for example, be in the form of switches (e.g., switches 108) or other multi-port network bridges that process and forward data at the data link layer. In some implementations, one or more of the nodes can be in the form of multilayer switches that operate at multiple layers of the Open Systems Connection (OSI) model (e.g., the data link and network layers). Although the term “switch” is used throughout this description, it is appreciated that this term can refer broadly to other suitable network data forwarding devices. For example, a general purpose computer can include suitable hardware and machine-readable instructions that allow the computer to function as a network switch. It is appreciated that the term “switch” can include other network datapath elements in the form of suitable routers, gateways and other devices that provide switch-like functionality for the network. Gateway 102 can, for example, be in the form of a network node that acts as an entrance to another network, such as Internet 114 or another suitable Wide Area Network (WAN) or Local Area Network (LAN).

The various nodes within network environment 100 are connected via one or more data channels (shown in solid lines), which can, for example be in the form of data cables or wireless data channels. Although a single link (i.e., a single line in FIG. 1) between each network node is illustrated, it is appreciated that each single link may include multiple wires or other wired or wireless data channels. Moreover, FIG. 1 further depicts wireless controller 104 as being connected to APs 110 via broken lines, which is intended to illustrate logical control channels between wireless controller 104 and APs 110. However, it is appreciated that wireless controller 104 may be directly connected to only one or a few APs, while being indirectly connected to other nodes of the network. As but one example, wireless controller 104 can be directly connected to a first AP via an Ethernet cable, while being indirectly connected to a second AP (e.g., by relying on the first AP to wireless communicate to the second AP control signals for the second AP or via a wired connection between the first and second APs). In certain implementations, wireless controller 104 can reside within Internet 114 or another network.

In some implementations, one or more network nodes within environment 100 (e.g., switch 108) can be used as network sensors as they may have information about dynamic network parameters. One example of such a dynamic network parameter may be a number of wireless clients assigned to a given AP attached to a port on a given switch. When polled, the devices can report this information to wireless controller 104.

In the example environment 100 depicted in FIG. 1, the various network nodes are in the form of intermediary nodes (e.g., switches 108, gateway 102, APs 110), a controller node (e.g., wireless controller 104), and host devices (wireless clients 112). It is appreciated however, that the implementations described herein can be used or adapted for networks including more or fewer devices, different types of devices, and different network arrangements. As an example, in some implementations, wireless controller 104 may operate as an intermediary node or a host device. As another example, in some implementations, such as in certain mesh networks, a backhaul of the network may be wireless instead of wired. In such an implementation, the APs themselves may relay data towards an AP that is connected to the wired backbone, to thereby use a wireless link between two APs as a wireless backhaul.

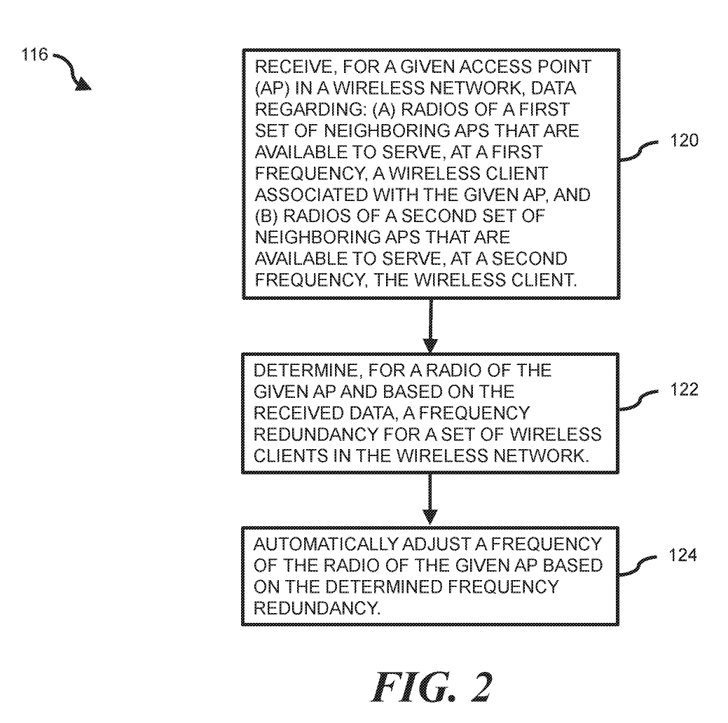

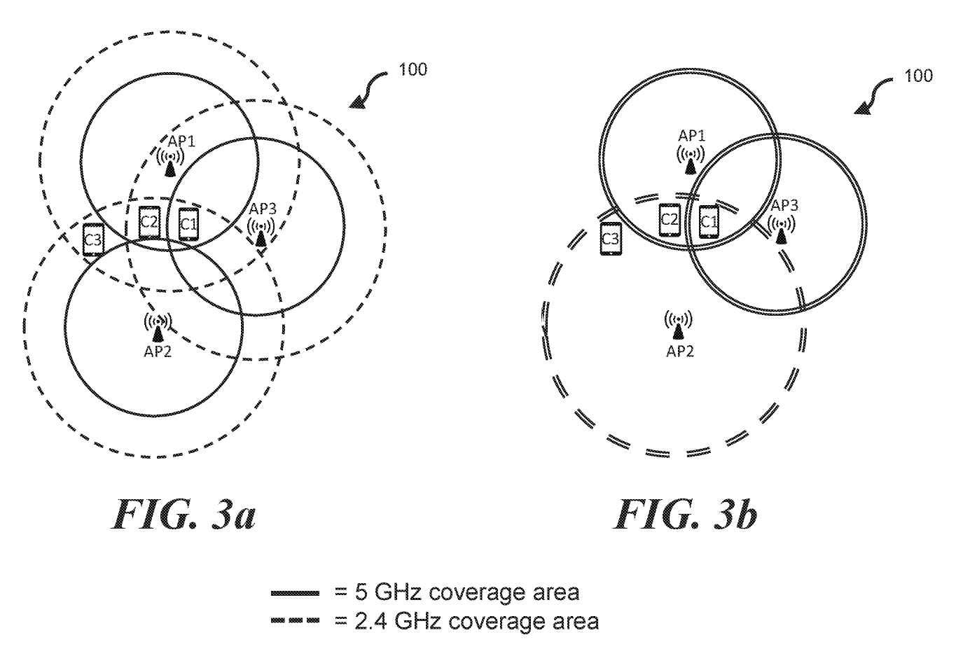

FIGS. 2 and 3a-3b illustrate an example implementation of the present disclosure. In particular, FIG. 2 depicts a flowchart for an example method 116 for AP radio frequency adjustment and FIGS. 3a-3b are example diagrams of frequency coverage before and after such adjustment. For illustration, the description of method 116 and its component steps make reference to the example network environment 100 of FIG. 1 and elements thereof, such as for example APs 110, wireless clients 112, etc. Moreover, network environment 100 of FIGS. 3a and 3b depicts three APs 110 and three wireless clients 112. However, it is appreciated that method 116 or aspects thereof can be used or otherwise applicable for any suitable network or network element described herein or otherwise. For example, method 116 can be applied to computer networks with different network topologies than those illustrated in FIG. 1 or 3a-b.

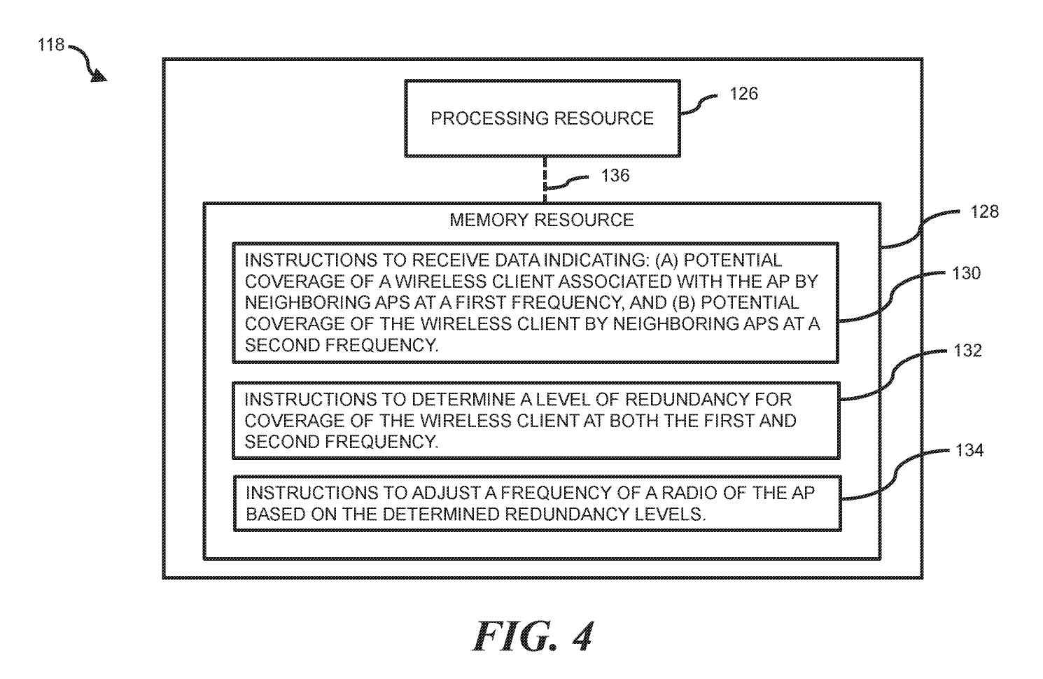

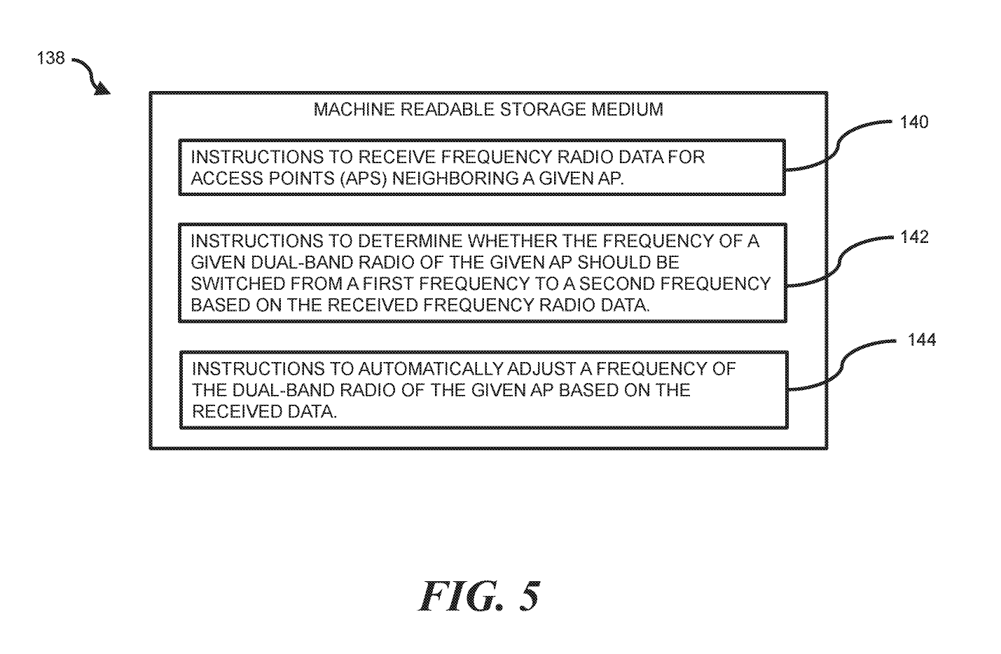

In some implementations, method 116 can be implemented or otherwise executed through the use of executable instructions stored on a memory resource (e.g., the memory resource of the computing device of FIG. 4), executable machine readable instructions stored on a storage medium (e.g., the medium of FIG. 5), in the form of electronic circuitry (e.g., on an Application-Specific Integrated Circuit (ASIC)), and/or another suitable form. Although the description of method 116 herein primarily refers to steps performed on AP 110 for purposes of illustration, it is appreciated that in some implementations, method 116 can be executed on another computing device within network environment 100 (e.g., wireless controller 104) or in data communication with network environment 100. In some implementations, method 116 can be executed on network devices in parallel (e.g., in a distributed computing fashion).

Method 116 of FIG. 2 includes receiving (at block 120), for a given AP 110 in network environment 100 (e.g., AP1 of FIGS. 3a-b), data regarding radios of a first set of neighboring APs (e.g., AP2 and AP3) that are available to serve, at a first frequency (e.g., 2.4 GHz), a wireless client (e.g., C1) associated with the given AP.

The received data can further include radios of a second set of neighboring AP (e.g., AP3) that are available to serve, at a second frequency (e.g., 5 GHz), the wireless client. The below table illustrates information that can be encoded in such received data and can include data for the various APs (AP1, AP2, and AP3), radios thereof (R1 and R2) and wireless clients (C1, C2, and C3) of the environment of FIG. 3a:

TABLE 1
RF coverage before adjustment (FIG. 3a)

| | C1 | C2 | C3 |
|---|---|---|---|
| AP1-R1 | 2.4 GHz | 2.4 GHz | 2.4 GHz |
| AP1-R2 | 5 GHz | 5 GHz | Not in range |
| AP2-R1 | 2.4 GHz | 2.4 GHz | 2.4 GHz |
| AP2-R2 | Not in range | Not in range | Not in range |
| AP3-R1 | 2.4 GHz | 2.4 GHz | Not in range |
| AP3-R2 | 5 GHz | Not in range | Not in range |

In this example, there is a partial overlap between the set of APs that neighbor A1 and can serve C1 at 2.4 GHz (i.e., AP2 and AP3) and the set of APs that neighbor A1 and can serve C1 at 5 GHz (i.e., AP3) as both sets include AP3 but do not both include AP2. It is appreciated that in some implementations, the first set of neighboring APs may be the same as the second set of neighboring APs (e.g., if both sets consist of AP2 and AP3) or there may be no overlap between the sets (e.g., if the first set consists of AP2 and the second set consists of AP3). It is further appreciated that in some situations, one or more sets of APs may be an empty set. For example, the set of APs that neighbor A1 and are able to serve C3 at 5 GHz is an empty set in the example of FIG. 3a.

Method 116 of FIG. 2 includes determining (at block 122), for a radio of the given AP and based on the received data, a frequency redundancy for a set of wireless clients in the wireless network. In some implementations, block 122 can determine the frequency redundancy of the radio of the given AP based on whether disabling operation of the radio of the given AP at a given frequency would reduce network connectivity service to wireless clients in the wireless network. In the example environment of FIG. 3a, wireless client C3 may be determined to have frequency redundancy in the 2.4 GHz network because both AP1-R1 and AP2-R1 can service C3 at 2.4 GHz. If, however, AP1-R1 is switched to 5 GHz (e.g., to better serve C1 and C2 at 5 GHz), then block 122 may determine that C3 no longer has frequency redundancy at 2.4 GHz. That is, if AP2-R1 is switched to 5 GHz then C3 will no longer be covered by any AP, thereby reducing network connectivity service for C3. In some implementations, block 122 can determine the frequency redundancy of the radio of the given AP based on whether disabling operation of the radio of the given AP at a given frequency would lead to other network conditions beyond just loss of service. For example, frequency redundancy may refer to redundancy to maintain a customer use cases, such as to achieve a desired throughput (or another QoS) over the network, enforce security provisions or access control policies for the network, or provide another suitable service or functionality. In some implementations, frequency redundancy can be based on a number of a number of wireless clients being served by the given AP at a given frequency.

Method 116 of FIG. 2 includes automatically adjusting (at block 124) a frequency of the radio of the given AP based on the determined frequency redundancy. For example, in some implementations, block 124 can include automatically switching the radio of the given AP to operate at a 2.4 GHz or a 5 GHz frequency. As a result, multiple radios of a single AP can be adjusted to operate at the same frequency. It is appreciated that the term “adjust” can refer to changing a frequency from a first frequency to a second frequency, as well as setting a radio to operate at a frequency (e.g., if the radio was previously turned off), or any other suitable adjustment. In some implementations, the frequency may be instructed to be active for a predefined amount of time (e.g., by associating a timer to the power profile) or a predefined number of bytes handled by a radio (e.g., by associating bytes counters to a radio of AP 110), and/or other conditions.

In accordance with a simplified example of the present disclosure, AP1 and AP3 may be instructed to set the frequency of both of their radios to 5 GHz and AP2 may be instructed to set the frequency of both of its radios to 2.4 GHz. An updated frequency coverage area table for the AP radios of FIG. 3b following the operation of block 124 is provided below:

TABLE 2
RF coverage after adjustment (FIG. 3b)

| | C1 | C2 | C3 |
|---|---|---|---|
| AP1-R1 | 5 GHz | 5 GHz | Not in range |
| AP1-R2 | 5 GHz | 5 GHz | Not in range |
| AP2-R1 | 2.4 GHz | 2.4 GHz | 2.4 GHz |
| AP2-R2 | 2.4 GHz | 2.4 GHz | 2.4 GHz |
| AP3-R1 | 5 GHz | Not in range | Not in range |
| AP3-R2 | 5 GHz | Not in range | Not in range |

As shown in tables 1 and 2, prior to adjustment, C1 was within the coverage area of two 5 GHz radios, whereas after adjustment, C1 was within the coverage area of four 5 GHz radios. Prior to adjustment, C2 was within the coverage area of one 5 GHz radio, whereas after adjustment C2 was within the coverage area of two 5 GHz radios. Prior to adjustment, C3 was within the coverage area of two 2.4 GHz radios, and after adjustment is still within the coverage area of two 2.4 GHz radios. As a result, both C1 and C2 will receive improved 5 GHz service, with no loss in network connectivity for C3. In view of this implementation, the combination of AP1, AP2, and AP3 are able to provide improved 2.4 GHz and 5 GHz service for C1, C2, and C3, even if AP1, AP2, and AP3 do not each provide 2.4 GHz and 5 GHz service.

In some implementations, block 124 can include adjusting a frequency of the radio of the given AP based on historical or dynamic network data. Such network data can, for example, be monitored by AP 110, another device in network environment 100, a network administrator, or another entity. Monitored data can, for example, refer to monitoring a rate of data packets (e.g., a number of packets over a period of time), a data transfer rate (e.g., a number of bytes of data over a period of time), or other suitable traffic statistics. For example, such monitoring can include monitoring for bandwidths, latencies, error rates, jitter rates, etc., for data traffic over the network. In some implementations, monitoring can be performed continuously, which can, for example, allow for “real-time monitoring.” In some implementations, monitoring is not performed continuously and/or can be configured to record data for later analysis or processing by controller 104 or another device.

The term “monitoring” as used herein may or may not include the act of “sensing” data within the network. That is, in some implementations, wireless controller 104 can be said to monitor usage of network resources based on information sensed by other devices, such as APs. For example, in some implementations, one or more APs within environment 100 can be used as “sensors” in the network as they may have information about dynamic network parameters. When polled via an interface the devices can report this information to wireless controller 104. In such a situation, wireless controller 104 can be said to monitor the network via information reported by the APs even though wireless controller 104 may not be sensing the data itself. In some situations, wireless controller 104 can also act as a sensor in the network based on dynamic network parameters recorded by wireless controller 104.

In some implementations, block 124 can include adjusting a frequency of the radio of the given AP based on usage criteria. The term “usage criteria” as used herein can, for example, be based on a packet rate limit for the control channel, a data rate limit for the control channel, or another suitable usage. For example, in some implementations, the usage criteria can be relevant to a QoS criteria, such as criteria relating to implementing time-sensitive network services, such as high speed computing networks where nodes connect compute servers, real-time multimedia services including Internet Protocol television (IPTV), video calls, online gaming, security camera streams, Voice over IP (VoIP) traffic, or other services. It is appreciated that such usage criteria can, for example, be manually determined by a network administrator or can be statically or dynamically determined by a device in the network, such as wireless controller 104, APs 110, or another computing device.

In some implementations, block 124 can include adjusting a frequency of the radio of the given AP based on whether usage criteria satisfies a single threshold value, whereas in other implementations, the usage criteria can be satisfied based on multiple criteria. For example, in some implementations, monitored usage can satisfy a usage criteria by: (a) being below a threshold value for jitter rate, (b) above a threshold value for packet rates, and (c) within a range of values for data rate. It is appreciated that more complicated criteria can be applied. For example, in some implementations the criteria is satisfied only if the packet rate is less than a threshold value and another condition is satisfied, such as a certain amount of time has elapsed since a starting time.

It is appreciated that one or more operations of method 116 can be performed periodically. For example, in some implementations, one or more of blocks 120, 122, and 124 (or other operations described herein) may be performed periodically. The various period times for blocks 120, 122, and 124 (or other operations described herein) may be the same or different times. For example, in some implementations, the period of block 120 is every 1 minute and the period of block 122 is every 10 minutes. It is further appreciated, that the period for a given block may be regular (e.g., every 1 minute) or may be irregular (e.g., every 1 minute during a first network condition, and every 5 minutes during a second network condition). In some implementations, one or more of block 120, 122, and 124 (or other operations described herein) may be non-periodic and may be triggered by some network or other event.

Although the flowchart of FIG. 2 shows a specific order of performance, it is appreciated that this order may be rearranged into another suitable order, may be executed concurrently or with partial concurrence, or a combination thereof. Likewise, suitable additional and/or comparable steps may be added to method 116 or other methods described herein in order to achieve the same or comparable functionality. In some implementations, one or more steps are omitted. For example, in some implementations, block 124 of adjusting a frequency of the radio can be omitted from method 116. It is appreciated that blocks corresponding to additional or alternative functionality of other implementations described herein can be incorporated in method 116. For example, blocks corresponding to the functionality of various aspects of computing device 118 otherwise described herein can be incorporated in method 116 even if such functionality is not explicitly characterized herein as a block in a method.

A specific example implementation will now be described. It is appreciated that this implementation may include certain aspects of other implementations described herein (and vice-versa), but it is not intended to be limiting towards other implementations described herein. In this specific example, a network of N APs is provided. Each AP is equipped with dual band dual radio, resulting in a total number of 2N radios. Let N₅ denote the number of radios assigned to 5 GHz, N₂ to 2.4 GHz. Also N₀ is for the number of radios turned off (or equivalently in a monitoring mode). It is appreciated that in such a network, N₅+N₂+N₀=2N. A Relative Network Density (RND) value can be used to denote a fraction of the number of 5 GHz radios with respect to the number of APs. That is, RND:=N₅/N. It is appreciated that 0.0<=RND<=2.0. When N₀=0, then RND=0.0, which indicates that all radios are 2 GHz. RND=2.0 indicates all radios are 5 GHz. RND can therefore be considered a control parameter with 1.0 as its default. RND can be increased when a network administrator wants to give more density and more capacity to 5 GHz. For example, if a RND is to be 1.5, then the network is to move half of the 2.4 GHz radios to 5 GHz, making N₅=1.5N and N₂=0.5N.

In some networks, some radios may be redundant based on topology, user mobility pattern, location, traffic demand, etc. A radio may be considered to be redundant when removing that radio from the network does not reduce the network connectivity service and the network goodput to the clients. As used herein, the term “goodput” can, for example, refer to an application-level throughput, such as a number of useful information bits delivered by the network to a certain destination per unit of time. It is appreciated that some degree of redundancy may be utilized for fallback purposes. However, redundancy may also indicate a degree of overinvestment, underutilization of network equipment, and in some cases, higher interference in a wireless network.

A Radio Redundancy Factor (RRF) can capture this notion quantitatively. RRF can be formulated in many suitable ways. For example, a Virtual Beacon Report (VBR) may be used in some implementations, such as RRF(x):=(Sum over each x's client the number of neighbor radios that can serve the client)/(1+the number of x's client). This formula can result in a few correlations, such as: (1) The more neighbors for a radio, the larger the RRF (2) The more the radio's clients, the less the RRF.

Network sampling can be referred to as a process of selecting a subset of radios from the network. Network sampling can be performed in many different ways. For example, a Density-Homogenizing Sampling can be used in some implementations. In one such implementations, a sample rate γ is selected, with 0<=γ<=1.0. Considering a network of N nodes, the sampling should select γ*N number of nodes. For purposes of this example, an Output set can be initialized as an empty set. Network nodes can be sorted by descending order according to RRF. The top node from the network can be moved to the Output set and the process can be repeated until the Output set size is of γ*N, up to the margin of an integer.

In operation, in a network of size N APs (i.e., 2N radios, with N 2.4 GHz radios and N 5 GHz radios) a desired value of RND can be selected by a network administrator or other entity. γ can be set to RND−1.0. If γ>0, then 2.4 GHz radios can be sampled and moved from the 2.4 GHz network to the 5 GHz network. If γ<0, then 5 GHz radios can be sampled and moved from the 5 GHz network to the 2.4 GHz network. In such an example, dynamic control of network density can be achieved by combining RND, RRF, and Network Sampling.

FIG. 4 is a diagram of a computing device 118 in accordance with the present disclosure. Computing device 118 can, for example, be in the form of an AP (e.g., AP 110), a wireless controller (e.g., wireless controller 104), or another suitable computing device within network environment 100 or in communication with network environment 100 or equipment thereof. As described in further detail below, computing device 118 includes a processing resource 126 and a memory resource 128 that stores machine-readable instructions 130, 132, and 134. For illustration, the description of computing device 118 makes reference to various aspects of the diagrams of FIGS. 1 and 3a-b as well as method 116 of FIG. 2. However it is appreciated that computing device 118 can include additional, alternative, or fewer aspects, functionality, etc., than the implementations described elsewhere herein and is not intended to be limited by the related disclosure thereof.

Instructions 130 stored on memory resource 128 are, when executed by processing resource 126, to cause processing resource 126 to receive data indicating: (a) potential coverage of a given wireless client 112 associated with a given AP 110 by neighboring APs 110 at a first frequency (e.g., 2.4 GHz), and (b) potential coverage of the given wireless client 112 by neighboring APs 110 at a second frequency (e.g., 5 GHz). Instructions 130 can incorporate one or more aspects of blocks of method 116 or another suitable aspect of other implementations described herein (and vice versa). For example, in some implementations, potential coverage can correlate to a number of radios of APs 110 assigned to a given frequency.

Instructions 132 stored on memory resource 128 are, when executed by processing resource 126, to cause processing resource 126 to determine a level of redundancy for coverage of the given wireless client 112 at both the first and second frequency. Instructions 132 can incorporate one or more aspects of blocks of method 116 or another suitable aspect of other implementations described herein (and vice versa). For example, in some implementations, a level of redundancy can be determined based on whether disabling operation of the radio of the given AP 110 at a given frequency would reduce network connectivity service to one or more wireless clients 112 within the network.

Instructions 134 stored on memory resource 128 are, when executed by processing resource 126, to cause processing resource 126 to adjust a frequency of a radio of the given AP 110 based on the determined redundancy levels. Instructions 134 can incorporate one or more aspects of blocks of method 116 or another suitable aspect of other implementations described herein (and vice versa). For example, in some implementations, instructions 134 are to cause processing resource 126 to adjust a frequency of the radio of the given AP 110 by switching the radio from a first frequency to a second frequency.

Processing resource 126 of computing device 118 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 128, or suitable combinations thereof. Processing resource 126 can, for example, include single or multiple cores on a chip, multiple cores across multiple chips, multiple cores across multiple devices, or suitable combinations thereof. Processing resource 126 can be functional to fetch, decode, and execute instructions as described herein. As an alternative or in addition to retrieving and executing instructions, processing resource 126 can, for example, include at least one integrated circuit (IC), other control logic, other electronic circuits, or suitable combination thereof that include a number of electronic components for performing the functionality of instructions stored on memory resource 128. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 126 can, for example, be implemented across multiple processing units and instructions may be implemented by different processing units in different areas of computing device 118.

Memory resource 128 of computing device 118 can, for example, be in the form of a non-transitory machine-readable storage medium, such as a suitable electronic, magnetic, optical, or other physical storage apparatus to contain or store information such as machine-readable instructions 130, 132, and 134. Such instructions can be operative to perform one or more functions described herein, such as those described herein with respect to method 116 or other methods described herein. Memory resource 128 can, for example, be housed within the same housing as processing resource 126 for computing device 118, such as within a computing tower case for computing device 118 (in implementations where computing device 118 is housed within a computing tower case). In some implementations, memory resource 128 and processing resource 126 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 128 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Memory resource 128 can be in communication with processing resource 126 via a communication link 136. Each communication link 136 can be local or remote to a machine (e.g., a computing device) associated with processing resource 126. Examples of a local communication link 136 can include an electronic bus internal to a machine (e.g., a computing device) where memory resource 128 is one of volatile, non-volatile, fixed, and/or removable storage medium in communication with processing resource 126 via the electronic bus.

In some implementations, one or more aspects of computing device 118 (e.g., AP 110, wireless controller 104, or other devices of a wireless network) can be in the form of functional modules that can, for example, be operative to execute one or more processes of instructions 130, 132, or 134 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of computing device 118 can, for example, include one or more machine-readable storage mediums and one or more computer processors.

In view of the above, it is appreciated that the various instructions of computing device 118 described above can correspond to separate and/or combined functional modules. For example, instructions 132 can correspond to a “frequency redundancy determination module” (e.g., module 106 of FIG. 1) to determine a level of redundancy for coverage of wireless client 112 at both the first and second frequency. Likewise, instructions 134 can correspond to a frequency adjustment module to adjust a frequency of a radio of AP 110 based on the determined redundancy levels. It is further appreciated that a given module can be used for multiple functions. As but one example, in some implementations, a single module can be used to both receive neighboring AP data (e.g., corresponding to the functionality of instructions 130) as well as to adjust a frequency of a radio of the given AP based on determined redundancy levels (e.g., corresponding to the functionality of instructions 134).

One or more nodes within the network environment 100 (e.g., wireless controller 104, AP 110, etc.) can further include a suitable communication module to allow networked communication between network equipment. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware of wireless controller 104, AP 110, or other network equipment. The communication module can, for example, include machine-readable instructions for use with communication the communication module, such as firmware for implementing physical or virtual network ports.

FIG. 5 illustrates a machine-readable storage medium 138 including various instructions that can be executed by a computer processor or other processing resource. In some implementations, medium 138 can be housed within an AP, such as AP 110, a wireless controller, such as wireless controller 104, or on another computing device within network environment 100 or in local or remote wired or wireless data communication with network environment 100.

For illustration, the description of machine-readable storage medium 138 provided herein makes reference to various aspects of computing device 118 (e.g., processing resource 126) and other implementations of the disclosure (e.g., method 116). Although one or more aspects of computing device 118 (as well as instructions such as instructions 130, 132, and 134) can be applied to or otherwise incorporated with medium 138, it is appreciated that in some implementations, medium 138 may be stored or housed separately from such a system. For example, in some implementations, medium 138 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 138 includes machine-readable instructions 140 stored thereon to cause processing resource 126 to receive frequency radio data for Access Points (APs) neighboring a given AP. Instructions 140 can, for example, incorporate one or more aspects of block 120 of method 116 or another suitable aspect of other implementations described herein (and vice versa). For example, in some implementations, radio frequency data can include a number of radios of APs 110 assigned to a given frequency.

Medium 138 includes machine-readable instructions 142 stored thereon to cause processing resource 126 to determine whether the frequency of a given dual-band radio of the given AP should be switched from a first frequency to a second frequency based on the received frequency radio data. Instructions 142 can, for example, incorporate one or more aspects of block 122 of method 116 or another suitable aspect of other implementations described herein (and vice versa). For example, in some implementations, this determination can be based on a level of frequency redundancy for wireless clients within the network. In some implementations, the determination can be based on whether disabling operation of the radio of an AP 110 at a frequency would reduce network connectivity service to one or more wireless clients 112 within the network.

Medium 138 includes machine-readable instructions 144 stored thereon to cause processing resource 126 to automatically adjust a frequency of the dual-band radio of the given AP based on the received data. Instructions 144 can, for example, incorporate one or more aspects of block 124 of method 116 or another suitable aspect of other implementations described herein (and vice versa). For example, in some implementations, instructions 144 are to cause processing resource 126 to adjust a frequency of a radio of the given AP 110 by switching the radio from a first frequency to a second frequency.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
receiving, for a given Access Point (AP) in a wireless network, data regarding: (a) radios of a first set of neighboring APs that are available to serve, at a first frequency, a wireless client associated with the given AP, and (b) radios of a second set of neighboring APs that are available to serve, at a second frequency, the wireless client;
determining, for a radio of the given AP and based on the received data, a frequency redundancy for a set of wireless clients in the wireless network; and
automatically adjusting a frequency of the radio of the given AP based on the determined frequency redundancy.

2. The method of claim 1, wherein the frequency redundancy of the radio of the given AP is determined based on whether disabling operation of the radio of the given AP at a given frequency would reduce network connectivity service to wireless clients in the wireless network.

3. The method of claim 1, wherein automatically adjusting the frequency of the radio of the given AP is further based on a number of clients being served by the given AP at a given frequency.

4. The method of claim 1, wherein the received data includes a number of radios of the first set of neighboring APs and a number of radios of the second set of neighboring APs.

5. The method of claim 1, wherein the method is performed by the given AP.

6. The method of claim 1, wherein the method is performed by a wireless controller.

7. The method of claim 1, wherein the first frequency is about 2.4 GHz and the second frequency is about 5 GHz.

8. The method of claim 1, wherein automatically adjusting the frequency of the radio of the given AP includes automatically switching the radio of the given AP to operate at a 5 GHz frequency.

9. The method of claim 1, wherein the given AP includes multiple radios operating at a 5 GHz frequency.

10. The method of claim 1, wherein the method includes:
periodically receiving neighboring radio data for the given AP;
periodically determining frequency redundancy for the radio of the given AP based on the received neighboring radio data; and
periodically and automatically adjusting a frequency of the radio of the given AP based on the determined frequency redundancy.

11. A non-transitory machine readable storage medium having stored thereon machine readable instructions to cause a computer processor to:
receive frequency radio data for Access Points (APs) neighboring a given AP;
determine whether the frequency of a given dual-band radio of the given AP should be switched from a first frequency to a second frequency based on the received frequency radio data; and
automatically adjust a frequency of the dual-band radio of the given AP based on the received data.

12. The medium of claim 11, wherein determining whether the frequency of a given dual-band radio of the given AP should be adjusted from a first frequency to a second frequency is further based on whether switching the frequency of the given dual-band radio would reduce network connectivity service to wireless clients in the wireless network.

13. A computing device comprising:
a processing resource; and
a memory resource storing machine readable instructions to cause the processing resource to:
receive data indicating: (a) potential coverage of a wireless client associated with a given Access Point (AP) by neighboring APs at a first frequency, and (b) potential coverage of the wireless client by neighboring APs at a second frequency;
determine a level of redundancy for coverage of the wireless client at both the first and second frequency; and
adjust a frequency of a radio of the given AP based on the determined redundancy levels.

14. The AP of claim 13, wherein the instructions are to cause the processing resource to adjust a frequency of the radio of the given AP by turning on the radio and enabling operation of the radio at the first or second frequency.

15. The AP of claim 13, wherein the instructions are to cause the processing resource to adjust a frequency of the radio of the given AP by switching the radio from the first frequency to the second frequency.
